(19) United States
(12) Patent Application Publication
(10) Pub. No.: US 2024/0399555 A1
(43) Pub. Date: Dec. 5, 2024

(54) PROTECTIVE CAP

(71) Applicant: YOSHINO GYPSUM CO., LTD., Tokyo (JP)

(72) Inventors: Katsumi NIIMI, Tokyo (JP); Masato OHTSUBO, Tokyo (JP); Masato UESHIMA, Tokyo (JP)

(21) Appl. No.: 18/698,571

(22) PCT Filed: Feb. 22, 2023
(86) PCT No.: PCT/JP2023/006561

§ 371 Date: Apr. 4, 2024

(30) Foreign Application Priority Data
Mar. 4, 2022 (JP) 2022-033932

(51) Int. Cl. B25F 5/02; B25B 21/00

(52) U.S. Cl. CPC B25F 5/02; B25B 21/00

(57) ABSTRACT

A protective cap to be mounted to a power type rotary tool for screw driving, the protective cap including a topside; an underside; and a through hole penetrating between the topside and the underside, wherein a surface of the topside includes a recess and a protrusion.

### TECHNICAL FIELD

The present invention relates to a protective cap.

### BACKGROUND OF THE INVENTION

As a work method for creating a plate-like body such as a ceiling board, a floor material, a wall material, etc., a work method in which a screw is driven in from the surface side of the plate-like body to fix the plate-like body to a base material, etc., has been known conventionally.

However, in the case where the screw is driven in too deeply when the plate-like body is fixed by the screw by using a power type rotary tool for screw driving, or when the screw driving is performed while the rotary tool is tilted, there is a case where a dent is formed in the plate-like body, the dent being a circular shape corresponding to the shape of the tip portion of the rotary tool, or an arcuate shape which is a part of a circle. In particular, in recent years, as ceiling boards, for example, the use of a soft plate-like body with a light specific gravity from the viewpoint of preventing the ceiling from falling has been increasing, and the aforementioned dent has been easily formed.

When a circular dent or the like is formed in a plate-like body such as a ceiling board, the dent becomes conspicuous such that the appearance is degraded when diagonally illuminated. Further, in order to prevent a circular dent or the like from being formed, it is required to carefully work so as not to drive the screw too far, and so as not to tilt the power type rotary tool for driving the screw, thereby reducing the work speed.

Therefore, in order to prevent a dent from being formed in the plate-like body, a protective cap to be mounted to the power type rotary tool for driving the screw has been studied conventionally.

For example, Patent Document 1 discloses an attachment for the power type rotary tool consisting of a face plate part and a mounting part, and having a soft part on the surface of the face plate part.

### RELATED ART DOCUMENTS

### Patent Document

Patent document 1: Japanese Unexamined Patent Application Publication No. 2009-39789

### SUMMARY OF THE INVENTION

### Problems to be Solved by the Invention

Incidentally, in recent years, further weight reduction has been attempted for plate-like bodies such as ceiling boards, in which dents are prone to being formed. For this reason, the attachment for a power type rotary tool disclosed in Patent Document 1 may not be able to sufficiently reduce the formation of a dent having circular shapes, etc., in plate-like bodies.

In view of the above problems of the conventional technology, an object of the present invention is to provide a protective cap capable of reducing the formation of a circular or arcuate shape dent in a plate-like body when a screw is driven in by a power type rotary tool for screw driving.

### Means for Solving the Problem

In order to solve the above problem, the present invention can provide a protective cap to be mounted to a power type rotary tool for screw driving, the protective cap including a topside; an underside; and a through hole penetrating between the topside and the underside, wherein a surface of the topside includes a recess and a protrusion.

### Effects of the Invention

According to the present invention, it is possible to provide a protective cap capable of preventing the formation of a circular or arcuate shape dent in a plate-like body when a screw is driven in by a power type rotary tool for screw driving.

### BRIEF DESCRIPTION OF THE DRAWINGS

FIG. 1A is an explanatory diagram of a protective cap in an embodiment of the present invention.

FIG. 1B is an explanatory diagram of a protective cap in an embodiment of the present invention.

FIG. 2 is an explanatory diagram of a protective cap in an embodiment of the present invention when the protective cap is mounted to a screw driving power type rotary tool.

FIG. 3A is an explanatory diagram of another configuration example of the protective cap in an embodiment of the present invention.

FIG. 3B is an explanatory diagram of another configuration example of the protective cap in an embodiment of the present invention.

FIG. 4A is a top view of the protective cap in an embodiment of the present invention.

FIG. 4B is a top view of the protective cap in an embodiment of the present invention.

FIG. 4C is a top view of the protective cap in an embodiment of the present invention.

FIG. 4D is a top view of a protective cap in an embodiment of the present invention.

FIG. 4E is a top view of a protective cap in an embodiment of the present invention.

FIG. 4F is a top view of a protective cap in an embodiment of the present invention.

FIG. 4G is a top view of a protective cap in an embodiment of the present invention.

FIG. 5A is an explanatory diagram of the cross-sectional shape of the recess.

FIG. 5B is an explanatory diagram of the cross-sectional shape of the recess.

FIG. 5C is an explanatory diagram of the cross-sectional shape of the recess.

FIG. 5D is an explanatory diagram of the cross-sectional shape of the recess.

FIG. 5E is an explanatory diagram of the cross-sectional shape of the recess.

FIG. 5F is an explanatory diagram of the cross-sectional shape of the recess.

FIG. 5G is an explanatory diagram of the cross-sectional shape of the recess.

FIG. 6A is an explanatory diagram of a chamfered portion.

FIG. 6B is an explanatory diagram of the chamfered portion.

FIG. 7A is an explanatory diagram of the groove portion provided on the outer surface.

FIG. 7B is an explanatory diagram of the groove portion provided on the outer surface.

FIG. 7C is an explanatory diagram of the groove portion provided on the outer surface.

FIG. 8A is an explanatory diagram of a fixing member.

FIG. 8B is an explanatory diagram of the fixing member.

FIG. 9A is an explanatory diagram of a cushion portion.

FIG. 9B is an explanatory diagram of the cushion portion.

FIG. 9C is an explanatory diagram of the cushion portion.

### DETAILED DESCRIPTION OF THE INVENTION

Embodiments of the present invention will be described below, but the present invention is not limited to the following embodiments, and various modifications and substitutions can be made to the following embodiments without departing from the scope of the present invention.

### [Protective Cap]

The protective cap according to the present embodiment is a protective cap mounted on a power-driven rotary tool for screw driving. Here, the screw includes all screws for fixing a plate-like body such as an interior wall plate or a ceiling plate to a base. The power type rotary tool (hereinafter also referred to simply as a “rotary tool”) for screw driving has a bit fixing part for fixing a bit having a tip shape corresponding to a slit-like groove portion provided on the screw head or a cross shape or the like. By rotating the bit fixing part by the power of a motor or the like provided inside the tool, the screw can be rotated via the bit and the screw can be driven into a plate-like body.

### (1) Outer Shape of Protective Cap

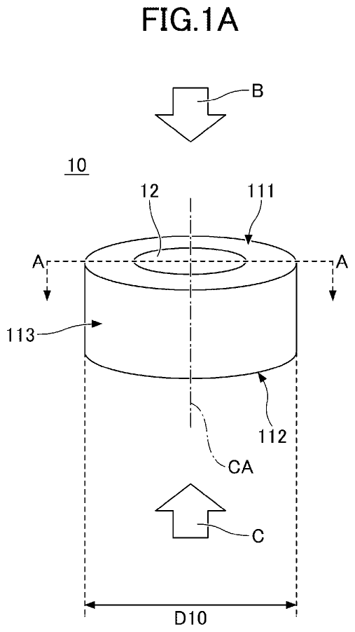

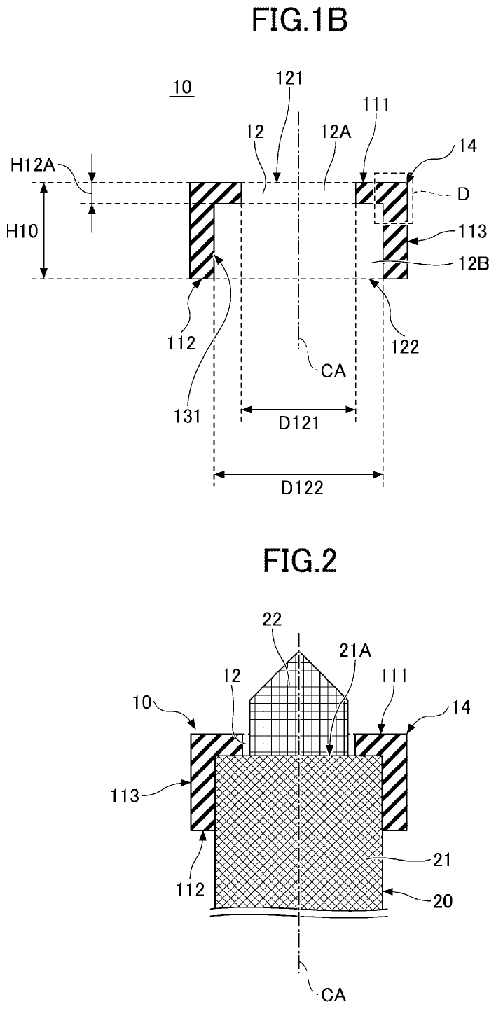

FIG. 1A illustrates a perspective view of the protective cap of the present embodiment, and FIG. 1B illustrates a cross-sectional view of the protective cap of the present embodiment. FIG. 1B is a cross-sectional view taken along line A-A of FIG. 1A.

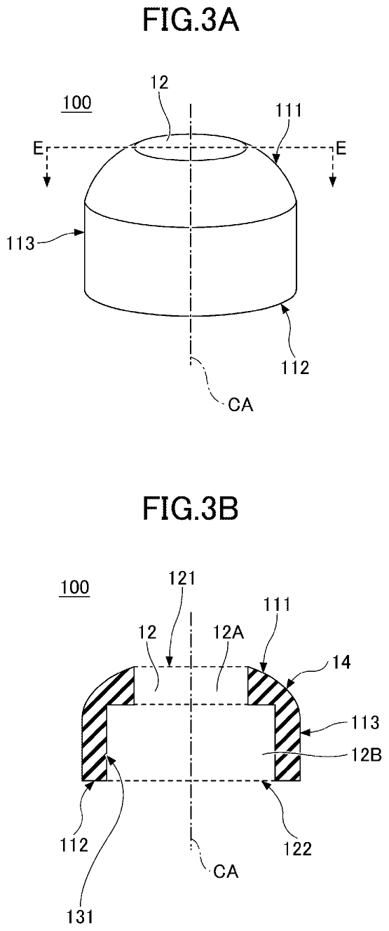

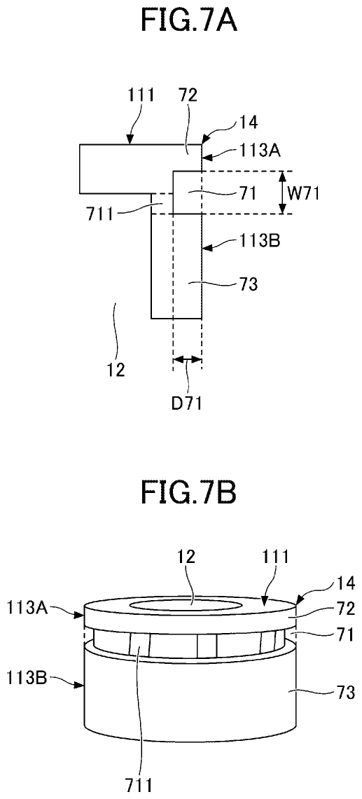

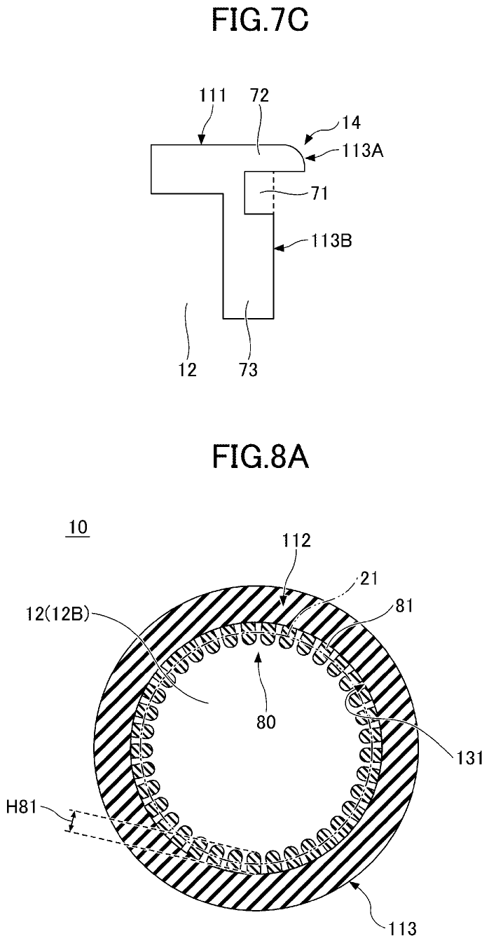

Although the outer shape of a protective cap 10 of the present embodiment is not particularly limited, the outer shape can be, for example, a columnar shape and, in particular, preferably a cylindrical shape as illustrated in FIG. 1A. As will be described later, the protective cap 10 of the present embodiment may be, for example, a case in which a topside 111 includes an inclined surface (see FIGS. 3A and 3B) or a case in which an outer surface 113 has a groove portion 71 (see FIGS. 7A to 7C). For this reason, the columnar shape and the cylindrical shape referred to herein are not limited to a shape in a geometrically strict sense.

As illustrated in FIGS. 1A and 1B, the protective cap 10 may include the topside 111 and an underside 112, and a through hole 12 penetrating between the topside 111 and the underside 112.

FIG. 2 illustrates an explanatory diagram when the protective cap 10 of the present embodiment is mounted on a rotary tool 20. FIG. 2 is a cross-sectional view of a plane through a central axis CA of the protective cap 10, when the protective cap 10 is mounted on the rotary tool 20.

As illustrated in FIG. 2, the protective cap 10 of the present embodiment can be mounted on a tip portion 21 of the rotary tool 20. At this time, the protective cap 10 can be mounted on the tip portion 21 of the rotary tool 20 by inserting the tip portion 21 of the rotary tool 20 into the through hole 12 from the underside 112 side of the protective cap 10.

The tip portion 21 of the rotary tool 20 is a bit fixing part (chuck part) for attaching a bit 22, and the tip portion 21 is the part of the rotary tool 20 that comes closest to the plate-like body (hereinafter, not illustrated) except for the bit 22 when driving a screw using the rotary tool 20. By mounting the protective cap 10 to the tip portion 21 of the rotary tool 20, it is possible to prevent a surface 21A facing the plate-like body at the tip portion 21 of the rotary tool 20 from coming into direct contact with the plate-like body when driving a screw into the plate-like body. Thus, it is possible to prevent the formation of a circular or arcuate shaped dent in the plate-like body.

Although the size of the protective cap 10 of the present embodiment is not particularly limited, for example, a maximum diameter D10 (see FIG. 1A) is preferably greater than or equal to 24 mm and less than or equal to 50 mm, and more preferably greater than or equal to 25 mm and less than or equal to 28 mm. By making the maximum diameter D10 greater than or equal to 24 mm, the protective cap 10 can be easily mounted to the tip portion 21 of the rotary tool 20, and when the protective cap 10 comes in contact with the plate-like body, the pressing pressure by the rotary tool 20 is distributed to sufficiently prevent the formation of a dent in the plate-like body. Further, by making the maximum diameter D10 less than or equal to 50 mm, the protective cap 10 can be used even in a narrow place such as an entry corner part, and the screwing position is not obstructed from the field of view and workability is not lowered.

The maximum diameter D10 means the diameter at the point where the outer shape has a circular shape and the diameter becomes the largest in the cross section perpendicular to the central axis CA.

Preferably, a thickness H10 (see FIG. 1B) of the protective cap 10 is greater than or equal to 11 mm and less than or equal to 20 mm so as not to be easily detached when mounted on the rotary tool 20 and so as to give a sufficient thickness to the portion of the tip portion 21 of the rotary tool 20 (see FIG. 2) covering the surface 21A facing the plate-like body. In particular, the thickness H10 of the protective cap 10 is more preferably greater than or equal to 11 mm and less than or equal to 16 mm.

Hereinafter, the parts of the protective cap 10 of the present embodiment will be described.

### (2) Through Hole

The through hole 12 is preferably disposed along the central axis CA of the protective cap 10 as illustrated in FIG. 1B. The through hole 12 is a hole for inserting the rotary tool 20 (see FIG. 2). As illustrated in FIGS. 1B and 2, the through hole 12 may have a first opening 121 for exposing the bit 22 of the rotary tool 20 (see FIG. 2) on the topside 111 side, and a second opening 122 for inserting the rotary tool 20 on the underside 112 side.

The through hole 12 may be configured such that the diameter D121 of the first opening 121, which is an opening on the topside 111 side, is smaller than the diameter D122 of the second opening 122 on the underside 112 side. Therefore, the through hole 12 may have a structure in which, for example, the first through hole 12A and the second through hole 12B having a cylindrical shape with different diameters are connected.

By making the diameter D121 of the first opening 121 smaller than the diameter D122 of the second opening 122, while exposing the bit 22 as illustrated in FIG. 2, the surface 21A facing the plate-like body at the tip portion 21 of the rotary tool 20 can be covered by the protective cap 10.

A length H12A (see FIG. 1B) of the first through-hole 12A is not particularly limited. The length H12A of the first through-hole 12A is the thickness of the member covering the surface 21A facing the plate-like body at the tip portion 21 of the rotary tool 20, and, therefore, it is preferable to select the length so as to sufficiently protect the plate-like body. The length H12A of the first through-hole 12A may be greater than or equal to 2 mm and less than or equal to 8 mm, for example.

### (3) Topside

### (3-1) Shape of Topside

As illustrated in FIG. 2, the topside 111 is a surface facing the plate-like body when the protective cap 10 is mounted to the rotary tool 20 and the plate-like body is subjected to screw driving.

The topside 111 may be a horizontal surface, such as the protective cap 10 illustrated in FIGS. 1A and 1B, or may include an inclined surface, such as a protective cap 100 illustrated in FIGS. 3A and 3B. That is, in the cross-section passing through the central axis CA of the protective cap 100, the topside 111 may include an inclined surface, for example, the topside 111 may be dome-shaped, as illustrated in FIGS. 3A and 3B. FIG. 3A is a perspective view of the protective cap 100, and FIG. 3B is a cross-sectional view taken along the line E-E in FIG. 3A. The protective cap 100 illustrated in FIGS. 3A and 3B may have the same configuration as the protective cap 10 illustrated in FIG. 1A and the like, except that the topside 111 includes an inclined plane, and, therefore, the corresponding members are denoted by the same reference numerals, and descriptions thereof are omitted.

The topside 111 includes an inclined surface as in the protective cap 100, and, therefore, if the rotary shaft of the bit 22 of the rotary tool 20 is tilted from the direction perpendicular to the plate-like body (hereinafter also described as “the state in which the rotary tool is tilted”) when performing screw-driving, it is particularly possible to prevent the formation of a dent in the plate-like body even when the topside 111 or a corner 14 between the topside 111 and the outer surface 113 contacts the plate-like body. When the topside 111 includes an inclined surface, the inclined surface is preferably an inclined surface lowered from the center side of the topside 111, i.e., the through hole 12 side, toward the outer surface 113 side. When the topside 111 has an inclined surface, the inclination of the inclined surface may be constant or may include a plurality of surfaces having different inclinations. The topside 111 may also include an inclined surface having an inclination that continuously changes as illustrated in FIGS. 3A and 3B.

When the topside 111 includes an inclined surface, the inclined surface and a chamfered portion described later may be provided continuously.

### (3-2) Recess and Protrusion

In the protective cap 10 of the present embodiment, the surface of the topside 111 may have a recess and a protrusion.

Although the depth of the recess from the topside 111 is not particularly limited, it is preferable that when the protective cap 10 is mounted on the rotary tool 20 (see FIG. 2), the recess is shallower than the thickness of the member covering the surface 21A facing the plate-like body at the tip portion 21 of the rotary tool 20. Therefore, it is preferable that α<β is satisfied, when the depth of the recess from the topside 111 is a (mm) and the thickness of the member covering the surface facing the plate-like body at the tip portion 21 of the rotary tool 20 is B (mm) when the protective cap 10 is mounted on the rotary tool 20 (see FIG. 2). As described above, β corresponds to the length H12A (see FIG. 1B) of the first through-hole 12A, and the relationship of β=H12A is satisfied. Hereinafter, the descriptions of α and β will be omitted.

It is more preferable that the depth of the recess from the topside 111 is less than or equal to the value obtained by subtracting 1 mm from the thickness of the member covering the surface 21A facing the plate-like body at the tip portion 21 of the rotary tool 20 when the protective cap 10 is mounted on the rotary tool 20 (see FIG. 2). More specifically, it is preferable that α≤β−1 is satisfied. For example, it is possible to set α=β−1.

Further, in order to enhance the durability of the protective cap 10, when the protective cap 10 is mounted to the rotary tool 20 (see FIG. 2), it is preferable that the portion obtained by subtracting the depth of the recess from the topside 111, from the thickness of the member covering the surface 21A facing the plate-like body at the tip portion 21 of the rotary tool 20, is 1 mm or more. Specifically, it is preferable that β−α≥1 is satisfied.

Furthermore, the depth of the recess from the topside 111 is more preferably less than or equal to the value obtained by subtracting 2 mm from the thickness of the member covering the surface 21A facing the plate-like body at the tip portion 21 of the rotary tool 20 when the protective cap 10 is mounted on the rotary tool 20 (see FIG. 2). More specifically, it is more preferable to that α≤β−2 is satisfied. For example, it is possible to set α=β−2.

The depth of the recess from the topside 111, i.e., the groove portion, may be constant or may change from place to place. For example, the depth of the recess from the topside 111 may change from the through hole 12 side, which is the center side, to the outer surface 113 side, which is the outer periphery side. For example, the depth of the recess may become deeper from the through hole 12 side toward the outer surface 113 side. That is, the depth of the recess may become deeper at the outer surface 113 side rather than the through hole 12 side. When the depth of the recess changes from the through hole 12 side toward the outer surface 113 side, the mode of the change is not particularly limited, and the depth may change linearly, for example.

Conventionally, when driving a screw into a plate-like body, if the screw is driven too deeply into the plate-like body or if the rotary tool 20 is a tilted state when driving a screw, and the tip portion of the rotary tool 20 hits the plate-like body, a circular or arcuate shaped dent has been formed in the plate-like body. The inventor of the present invention has investigated a protective cap which can prevent the formation of a dent. As a result, it was found that by providing a recess and a protrusion on the topside of the protective cap 10, that is, the surface facing the plate-like body on which the screwing operation is performed, when the topside of the protective cap comes in contact with the plate-like body, the protrusion easily collapses, and the pressing force against the plate-like body by the rotary tool 20 can be reduced. Therefore, by providing the recess and the protrusion on the topside of the protective cap 10, when the topside 111 of the protective cap 10 comes in contact with the plate-like body, it is possible to prevent the formation of a circular or arcuate shape dent in the plate-like body.

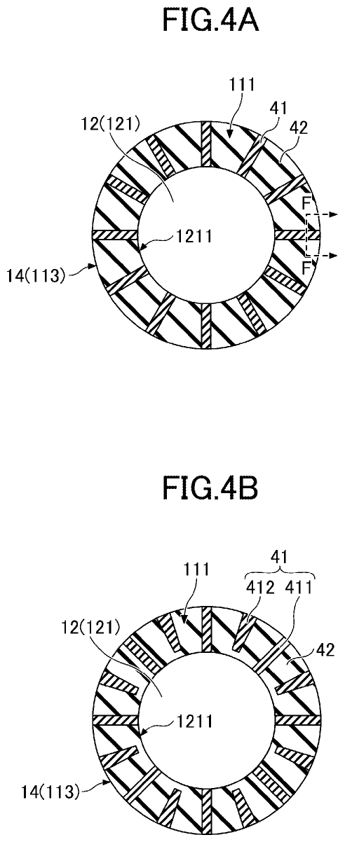

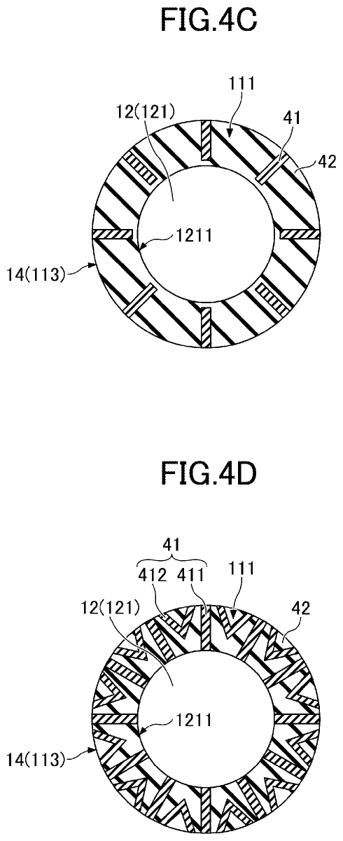

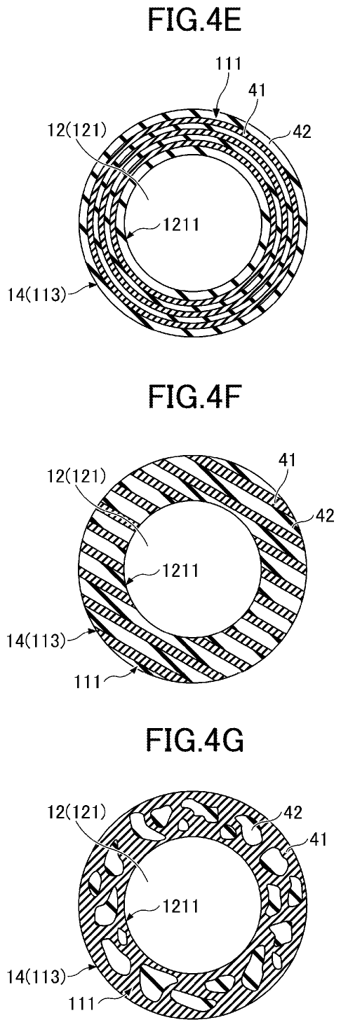

Although the shapes of the recess and the protrusion are not particularly limited, for example, a recess 41 can be shaped as illustrated in FIGS. 4A to 4G when the topside 111 is viewed from above the topside 111, i.e., along the block arrow B of FIG. 1A.

For example, as illustrated in FIGS. 4A to 4D, the shape of the recess 41 can be a radial shape or a shape including a radial shape. The radial shape refers to a shape in which a first opening 121 is located on the center side of the topside 111, a corner 14 is located on the outer periphery side from the through hole 12 side, and a plurality of linear recesses 41 are located toward the outer surface 113 side.

For example, it is possible to connect the outer periphery 1211 of the first opening 121 and the corner 14 (the outer surface 113), as in the topside 111 illustrated in FIG. 4A.

Further, it is also possible to form the first recess 411, which is a part of the recess 41, so as to connect the outer periphery 1211 of the first opening 121 and the corner 14, and form the other recess, that is, a second recess 412 so as not to extend from the corner 14 to the first opening 121, as in the topside 111 illustrated in FIG. 4B. As illustrated in FIG. 4B, when viewed from above, the width of the first recess 411 and the second recess 412 may be different, and the width may change in the second recess 412 as in the second recess 412. Although FIG. 4B illustrates an example in which the width of the second recess 412 increases from a position close to the first opening 121 to the corner 14, the manner in which the width of the recess 41 changes is not limited to this configuration.

FIG. 4B and the like illustrate a configuration in which the recess 41 has a width when viewed from above the topside 111, but the recess is not limited to this configuration. The recess 41 may have a linear slit (streak) as viewed from above the topside 111, that is, a configuration in which the recess 41 does not have a width as illustrated in FIG. 4B and the like, unlike the configuration in FIG. 4B and the like. Here, the width and the configuration of the recess 41 have been described by using FIG. 4B as an example, but the same can be applicable to cases other than FIG. 4B.

As in the topside 111 of FIG. 4C, the recess 41 may be formed in a radial shape so as not to extend from the corner 14 to the first opening 121.

As in the topside 111 of FIG. 4D, the recess 41 may be formed to have a radial shape and other shapes. For example, in FIG. 4D, the second recess 412 may have a first recess 411 having a radial shape and a second recess having a V-shape.

FIG. 4D illustrates an example in which the first recess 411 is formed so as to connect the outer periphery 1211 of the first opening 121 with the corner 14, but the recess is not limited to this embodiment. The first recess 411 may be formed so as not to extend from the corner 14 to the first opening 121, such as the second recess 412 illustrated in FIG. 4B or the recess 41 illustrated in FIG. 4C, or may be formed so as not to extend from the first opening 121 to the corner 14.

Further, the second recess 412 may have a shape other than a V-shape.

As illustrated in FIG. 4E, the recess 41 may have a concentric shape.

As illustrated in FIG. 4F, the recess 41 may be formed in a stripe shape (stripe pattern). The recess may be formed in a lattice shape by forming stripe patterns so as to intersect.

That is, the shape of the recess formed on the surface of the topside 111 viewed from above the topside 111 may include one or more types of shapes selected from, for example, a radial shape, concentric circles, and stripes.

Note that the recess 41 is not limited to the regular shapes illustrated in FIGS. 4A to 4F, but may have protrusions 42 having random shapes and the recesses 41 provided to surround the protrusions as illustrated in FIG. 4G.

In any of the cases of FIGS. 4A to 4G, the protrusions 42 are formed between the recesses 41 of the topside 111.

Although the ratio of the area occupied by the protrusions 42 of the topside 111 of the protective cap 10 is not particularly limited, for example, the occupied area is preferably 90% or less, more preferably 80% or less, and even more preferably 60% or less, in order to facilitate crushing when the protrusions come in contact with a plate-like body. The lower limit of the ratio of the area occupied by the protrusions 42 of the topside 111 of the protective cap 10 is also not particularly limited, but the occupied area is preferably 10% or more, and more preferably 20% or more.

The area of the topside 111 of the protective cap 10 is the area excluding the area of the first opening 121 of the through hole 12 from the area enclosed by the outer surface 113. In the case of having a first outer peripheral area 72 and a second outer peripheral area 73 having different outer diameters as illustrated in FIG. 7C described later, the area excluding the area of the first opening 121 from the area enclosed by the outer surface 113A of the first outer peripheral area 72 closest in distance from the topside 111, can be the area of the topside 111. Further, the area occupied by the protrusion 42 is the area excluding the recess 41 and the chamfered portion described later from the area of the topside 111.

When the topside 111 of the protective cap 10 is in contact with the plate-like body, the shape of the protrusion changes as described above, thereby preventing the formation of a dent in the plate-like body. Depending on the degree of the pushing into the plate-like body, there may be cases where a dent corresponding to the protrusion is formed in the plate-like body, but the dent caused by the protrusion being in contact with the plate-like body is less noticeable than a circular dent caused by the outer periphery of the topside being in contact with the plate-like body.

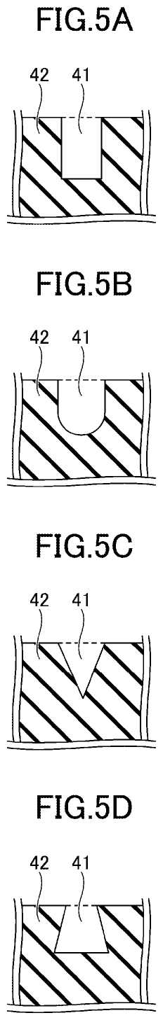

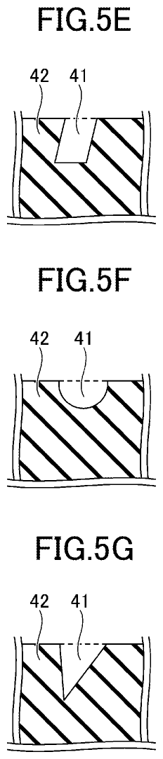

The cross-sectional shape of the recess 41 is not particularly limited and can be any shape. Examples of the configuration of the cross-sectional shape of the recess 41 will be described with reference to FIGS. 5A to 5G. FIGS. 5A to 5G are cross sections perpendicular to the longitudinal direction of the recess 41 when the recess has a linear shape, and correspond to, for example, the cross section of the line F-F in FIG. 4A.

The cross section of the recess 41 may have a square shape as illustrated in FIG. 5A, a U-shape as illustrated in FIG. 5B, a V-shape (triangle) as illustrated in FIG. 5C, and the like.

The quadrilateral shape is not limited to the rectangle illustrated in FIG. 5A or an orthogonal shape such as a square, but may include various quadrilateral shapes such as the trapezoid illustrated in FIG. 5D and the parallelogram illustrated in FIG. 5E.

The U-shape includes various shapes such as a semicircle as illustrated in FIG. 5F, in which the bottom side is an arc shape.

The V-shape is not limited to an isosceles triangular shape as illustrated in FIG. 5C, but may include various triangular shapes such as a right-angled triangle, which is the shape of the katakana character “re” in Japanese, as illustrated in FIG. 5G.

As described above, the cross-sectional shape of the recess 41 preferably includes one or more types of shapes selected from, for example, a quadrilateral shape, a U-shape, a V-shape, and the like.

According to an examination by the inventor of the present invention, when the cross-sectional shape of the recess 41 has a certain width on the bottom surface side such as a quadrilateral shape, a U-shape, and the like, the protrusion 42 is particularly prone to collapse, and the formation of a dent in the plate-like body can be particularly prevented. Therefore, it is more preferable that the cross-sectional shape of the recess 41 includes one or more types selected from a quadrilateral shape and a U-shape.

Note that the topside of the same protective cap 100 may include recesses of different cross-sectional shapes and depths.

### (4) Chamfered Portion

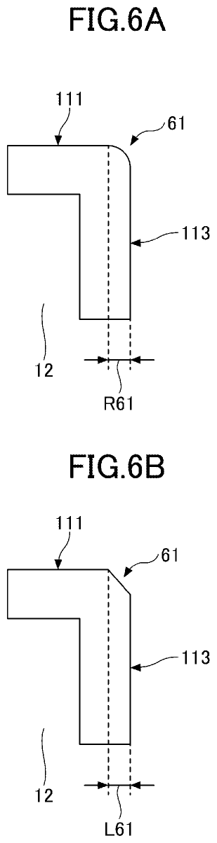

As illustrated in FIGS. 6A and 6B, the protective cap 10 of the present embodiment may have a chamfered portion 61 at which the corner 14 (see FIG. 1B) between the topside 111 and the outer surface 113 is chamfered. That is, the protective cap 10 may have the chamfered portion 61 in which the part between the topside 111 and the outer surface 113 is chamfered. The chamfered portion 61 may be formed over the entire outer periphery of the topside 111.

FIGS. 6A and 6B are enlarged views of the area D in FIG. 1B in the case where the chamfered portion 61 is provided.

As described above, the protective cap 10 has the chamfered portion 61 in which the portion between the topside 111 and the outer surface 113 is chamfered, and, therefore, it is possible to prevent the formation of a dent in the plate-like body even when the rotary tool 20 (see FIG. 2) is used to perform screw-driving in a tilted state and the chamfered portion 61 contacts the plate-like body.

Although the shape of the chamfered portion 61 is not particularly limited, for example, in a cross-section through the central axis CA of the protective cap 10, the chamfered portion 61 may have an arc shape, for example, as illustrated in FIG. 6A, or a straight shape, as illustrated in FIG. 6B.

When the shape of the chamfered portion 61 in the cross-section is an arc shape, as illustrated in FIG. 6A, the radius R61 of the chamfered portion is preferably, for example, 0.5 mm to 1.5 mm.

When the shape of the chamfered portion 61 in the above-described cross-section is a straight line shape as illustrated in FIG. 6B, it is preferable that, with respect to an isosceles right triangle whose hypotenuse is a straight line of the chamfered portion 61 in the cross-section, a length L61 of the sides on either side of the right angle is, for example, 0.5 mm to 1.5 mm.

### (5) Groove Portion

For example, the protective cap of the present embodiment may have a groove portion 71 (see FIGS. 7A and 7B) formed along the circumferential direction on the outer surface 113 (see FIGS. 1A and 1B).

FIG. 7A is an enlarged view of the area D in FIG. 1B when the groove portion 71 is provided. FIG. 7B is a perspective view of the protective cap with the groove portion 71 provided.

By providing the groove portion 71, a first outer peripheral area 72 located above the groove portion 71 is easily deformed toward the groove portion 71. Therefore, even when the rotary tool 20 performs screw-driving in a tilted state, and the corner 14 corresponding to the outer periphery of the topside 111 comes into contact with the plate-like body, the formation of a dent in the plate-like body can be prevented.

Even when the groove portion 71 is provided, the corner 14 can be chamfered as described above, and the chamfered portion 61 (see FIG. 6) can be provided.

The position in the height direction where the groove portion 71 is provided, and the depth D71 and the width W71 of the groove portion 71 are not particularly limited, but it is preferable to select the size and the position such that the first outer peripheral area 72 located above the groove portion 71 is easily deformed toward the groove portion 71.

In FIGS. 7A and 7B, an outer surface 113A of the first outer peripheral area 72 located above the groove portion 71 and an outer surface 113B of a second outer peripheral area 73 located below the groove portion 71 are located on the same plane, but the configuration is not limited thereto.

For example, as illustrated in FIG. 7C, an outer surface 113A of the first outer peripheral area 72 located above the groove portion 71 may be positioned outside an outer surface 113B of the second outer peripheral area 73 located below the groove portion 71. The outside means the direction away from the central axis CA of the protective cap 10. FIG. 7C is an enlarged view of the area D in FIG. 1B when the groove portion 71 is provided and the outer surface 113A of the first outer peripheral area 72 is positioned outside the outer surface 113B of the second outer peripheral area 73. Therefore, the center axis CA is positioned on the left side in FIG. 7C, and the outer surface is positioned on the right side in FIG. 7C.

By positioning the outer surface 113A of the first outer peripheral area 72 outside the outer surface 113B of the second outer peripheral area 73, the first outer peripheral area 72 is particularly easily deformed toward the groove portion 71. Therefore, even when the rotary tool 20 performs screw-driving in a tilted state and the corner 14 that corresponds to the outer circumference of the topside 111 comes into contact with the plate-like body, the formation of a dent in the plate-like body can be particularly prevented.

As illustrated in FIGS. 7A and 7B, for example, the groove portion 71 may have a communication hole 711 connecting the groove portion 71 and the through hole 12. By providing the communication hole 711, the first outer peripheral area 72 can be particularly easily deformed. As a result, the formation of a dent in the plate-like body can be particularly prevented.

### (6) Fixing Member

The protective cap 10 of the present embodiment may have a fixing member 80 including a plurality of the protrusions 81 in the inner peripheral surface 131 of the through hole 12.

The outer diameter of the tip portion 21 (see FIG. 2) of the rotary tool 20 may vary depending on the manufacturer or the like of the rotary tool 20. If the inner diameter of the through hole 12 of the protective cap 10 is small relative to the outer diameter of the tip portion 21, a deflection or the like may occur on the outer surface 113 of the protective cap 10, and the protective cap 10 may not be fixed to the tip portion 21. If the inner diameter of the through hole 12 of the protective cap 10 is large relative to the outer diameter of the tip portion 21, a gap may be formed between the inner peripheral surface of the protective cap 10 and the tip portion 21, and the protective cap 10 may not be fixed to the tip portion 21.

Therefore, if the outer diameter of the tip portion 21 of the rotary tool 20 is significantly different from the inner diameter of the through hole 12 of the protective cap 10, the position of the protective cap 10 may shift during use of the rotary tool 20, and the plate-like body may not be sufficiently protected.

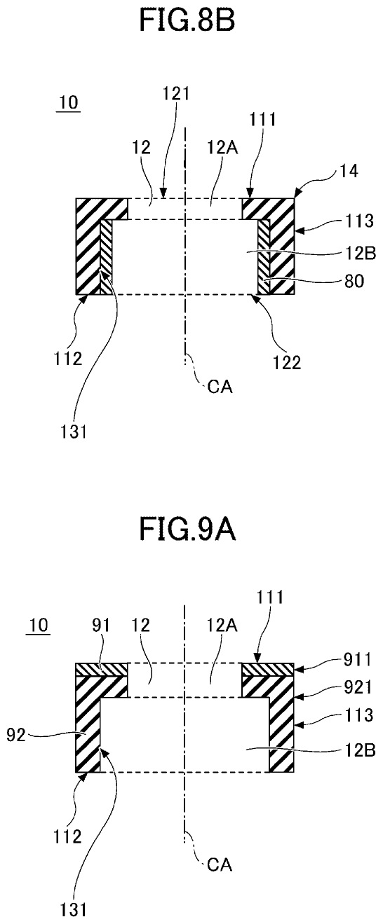

Therefore, it is preferable that the protective cap 10 of the present embodiment has the fixing member 80 including a plurality of the protrusions 81 in the inner peripheral surface 131 of the through-hole 12, especially in the inner peripheral surface (inner side surface) of the second through-hole 12B (see FIGS. 8A and 8B), as described above, so that the protective cap 10 can be attached regardless of the size of the tip portion 21 of the rotary tool 20.

The fixing member 80 will be described with reference to FIGS. 8A and 8B. FIG. 8A is a bottom view of the protective cap 10 with the fixing member 80 and corresponds to a view along the block arrow C in FIG. 1A. FIG. 8B is a cross-sectional view at line A-A (see FIG. 1A) of the protective cap 10 with the fixing member 80.

The fixing member 80 may include a plurality of the protrusions 81, as illustrated in FIG. 8A, for example, and a plurality of the protrusions 81 may be provided along the circumferential direction of the inner peripheral surface 131 of the through hole 12, as illustrated in FIG. 8A. By providing a plurality of the protrusions 81 on the inner peripheral surface 131 of the through hole 12 in this manner, when the rotary tool 20 is inserted into the through hole 12 from the underside 112 of the protective cap 10, the protrusions can contract in accordance with the size of the tip portion 21 indicated by the two-dot chain line, so that the protrusions 81 can adhere to the outer surface of the tip portion 21. Therefore, the height H81 and the like of the protrusions 81 can be selected in accordance with the size range of the tip portion 21 of the corresponding rotary tool 20.

In FIG. 8A, the size and shape of the protrusion 81 are constant, but the fixing member 80 may include the protrusions 81 having different heights and shapes.

The fixing member 80 may be provided on at least a part of the inner peripheral surface 131 of the through hole 12. However, in order to enhance adhesion to the tip portion 21 (see FIG. 2) of the rotary tool 20, it is preferable that the fixing member be provided in pleat-like shapes on the entire inner peripheral surface 131 of the second through hole 12B, as illustrated in FIG. 8B, for example.

### (7) Material of the Protective Cap, Cushion Portion

The material forming the protective cap 10 of the present embodiment is not particularly limited. However, from the viewpoint of protecting the plate-like body by deforming in accordance with the shape of the tip portion 21 (see FIG. 2) of the rotary tool 20 inserted into the through hole 12, it is preferable to include an elastic material and more preferably to be formed of an elastic material. For example, rubber may be used as an elastic material, and silicone rubber may be particularly preferably used as an elastic material. This is because, in the case of silicone rubber, it is possible to prevent chips, which are produced when a screw is struck on the plate-like body, from adhering to the protective cap 10 and to prevent the surface of the plate-like body from being stained.

Other than the above silicone rubber, as the elastic material included in the protective cap 10, for example, one or more types of elastic materials selected from natural rubber, nitrile rubber, silicon rubber, fluorine rubber, urethane rubber, acrylic rubber, isoprene rubber, styrene rubber, butadiene rubber, butyl rubber, isobutylene isoprene rubber, ethylene propylene rubber, ethylene propylene diene rubber, ethylene vinyl acetate rubber, chloroprene rubber, hyperon (chlorosulfonated polyethylene) chlorinated polyethylene rubber, epichlorohydrin rubber, polysulfide rubber, etc., may be used. In this case, the rubber hardness of the elastic material is preferably 30 or more and 90 or less, and more preferably 40 or more and 80 or less. That is, the protective cap 10 of the present embodiment may include a portion having a rubber hardness in the above range, preferably 30 or more and 90 or less, and more preferably 40 or more and 80 or less.

This is because, when the rubber hardness is in the above range, the protective cap 10 can be easily deformed according to the shape of the tip portion 21 of the rotary tool 20 and fixed to the rotary tool 20. Further, when the rubber hardness is in the above range, the protective cap 10 can exhibit a sufficient cushioning property and particularly prevent the formation of a dent in the plate-like body.

In the present specification, rubber hardness means Type A durometer hardness, that is, rubber hardness measured by the Type A durometer hardness test defined in JIS K 6253-3 (2012).

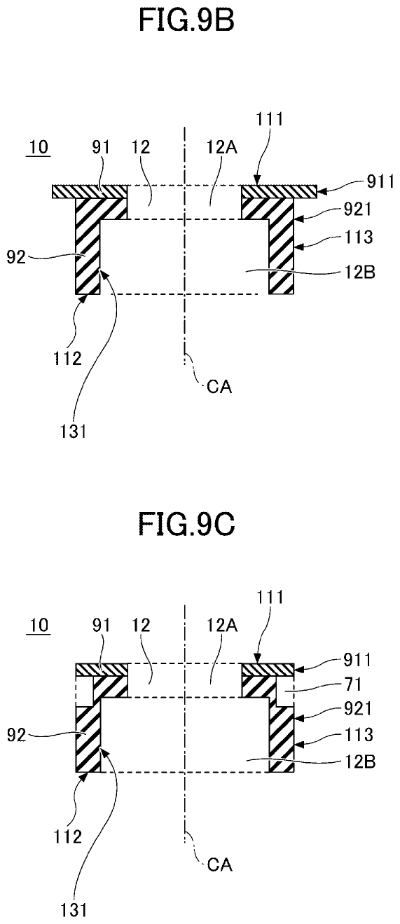

The protective cap 10 of the present embodiment may also have a cushion portion 91 on the surface of the topside 111, as illustrated in FIGS. 9A to 9C, the cushion portion 91 including a material having a lower rubber hardness than the other portions. FIGS. 9A to 9C are cross-sectional views of the protective cap 10 at line A-A in FIG. 1A when the cushion portion 91 is provided.

By providing the cushion portion 91 on the topside 111 in this manner, it is possible to particularly prevent the formation of a dent in the plate-like body even when the topside 111 of the protective cap 10 contacts the plate-like body.

As illustrated in FIGS. 9A to 9C, the cushion portion 91 is preferably provided so as to constitute, for example, the entire topside 111 of the protective cap 10.

If the portion of the protective cap 10 other than the cushion portion 91 is a main body portion 92, a side surface 911 of the cushion portion 91 and a side surface 921 of the main body portion 92 may have the same distance from the central axis CA as illustrated in FIG. 9A.

Further, as illustrated in FIG. 9B, the side surface 911 of the cushion portion 91 may have a shape located outside the side surface 921 of the main body portion 92. The outside here means the direction away from the central axis CA of the protective cap 10.

By arranging the side surface 911 of the cushion portion 91 outside the side surface 921 of the body portion 92, the cushion portion 91 can easily be deformed downward, that is, toward the underside 112. Therefore, even when the rotary tool 20 performs screw-driving in a tilted state and the outer periphery of the topside 111 comes into contact with the plate-like body, the formation of a dent in the plate-like body can be particularly prevented.

As illustrated in FIG. 9C, the aforementioned groove portions 71 can also be provided on the side surface 921 of the main body part 92. By providing the groove portions 71, the cushion portions 91 can easily be deformed downward, i.e., toward the underside 112. Therefore, even when the rotary tool 20 performs screw-driving in a tilted state and the outer periphery of the topside 111 comes in contact with the plate-like body, the formation of a dent in the plate-like body can be particularly prevented.

The main body part 92 can also be provided with the chamfered portion 61 in the same manner as in the case of the protective cap 10 described with reference to FIGS. 6A and 6B. The cushion portion 91 may be configured to cover not only the flat surface portion of the topside 111 side of the protective cap 10, that is, the topside of the main body portion 92, but also the portion of the chamfered portion, for example, at least a part of the chamfered portion, when the body portion 92 is provided with a chamfered portion as described above.

When the cushion portion 91 is provided, the cushion portion 91 may contain a material having lower rubber hardness than the other portion, that is, the main body portion 92, as described above, and may be configured of a material having lower rubber hardness. The rubber hardness of the cushion portion 91 is preferably 75 or less, for example.

Further, the rubber hardness of the cushion portion 91 is preferably 10 or more lower than the rubber hardness of the plate-like body to which a screw is to be driven in. Therefore, when the rubber hardness of the cushion portion 91 is H91 and the rubber hardness of the plate-like body is HB, it is preferable that HB−H91≥10. When the rubber hardness of the plate-like body varies depending on the position, the rubber hardness HB of the plate-like body means the rubber hardness around the position where the screw is driven in among the plate-like body.

The cushion portion 91 may be made of the same elastic material as the main body part 92, or may be made of a material such as felt, plastic foam, or gel-like body. In the case of felt, the rubber hardness can also be evaluated by the Type A durometer hardness test described above.

The main body part 92 may include, for example, the rubber hardness described above, i.e., an elastic material having a rubber hardness of 30 or more and 90 or less, and may be formed of the elastic material.

The cushion portion 91 and the main body part 92 may be joined to form an integral molded article, or these members may be bonded to each other with an adhesive or adhesive tape.

The color of the topside 111 of the protective cap 10 is preferably close to that of the plate-like body. This is because even when a part of the protective cap 10 adheres to the plate-like body due to friction, when the color of the protective cap is close to that of the plate-like body, the appearance can be prevented from being damaged. Plate-like bodies such as ceiling boards, floor materials, and wall materials are generally close to gray or white, and, therefore, it is preferable that the topside 111 of the protective cap 10 is also gray or white. When the cushion portion 91 is provided as described above, it is preferable that at least the topside of the cushion portion 91 has the above color tone.

Although the protective cap has been described in the above embodiments, the present invention is not limited to the above embodiments. Various variations and changes can be made within the scope of the gist of the present invention described in the claims.

The present international application is based upon and claims priority to Japanese Patent Application No. 2022-033932 filed on Mar. 4, 2022, the entire contents of which are incorporated herein by reference.

### EXPLANATION OF REFERENCE NUMERALS

10, 100 protective cap
H10 height
D10 diameter
CA central axis
111 topside
112 underside
113 outer surface
12 through hole
12A first through hole
H12A length
12B second through hole
121 first opening
D121 diameter
122 second opening
D122 diameter
131 inner peripheral surface
14 corner
20 rotary tool
21 tip portion
22 bit
21A surface
41 recess
411 first recess
412 second recess
42 protrusion
61 chamfered portion
R61 radius
L61 length
71 groove portion
711 communication hole
72 first outer peripheral area
73 second outer peripheral area
113A outer surface
113B outer surface
D71 depth
W71 width
80 fixing member
81 protrusion
H81 height
91 cushion portion
911 side surface
92 main body portion
921 side surface

1. A protective cap to be mounted to a power type rotary tool for screw driving, the protective cap comprising:
a topside; and
an underside; wherein
a through hole penetrates between the topside and the underside, wherein
a surface of the topside includes a recess and a protrusion.

2. The protective cap according to claim 1, wherein a shape of the recess formed on the surface of the topside, as viewed from above the topside, includes one or more shapes selected from a radial shape, a concentric circle, and a stripe shape.

3. The protective cap according to claim 1, wherein a cross-sectional shape of the recess includes one or more shapes selected from a square shape, a U-shape, and a V-shape.

4. The protective cap according to claim 1, wherein a depth of the recess increases from a side of the through hole toward an outer surface side.

5. The protective cap according to claim 1, wherein the topside includes an inclined surface in a cross-section through a central axis of the protective cap.

6. The protective cap according to claim 1, further comprising:
a groove formed along a circumferential direction on an outer surface of the protective cap.

7. The protective cap according to claim 1, further comprising:
a chamfered portion at which a portion between the topside and an outer surface of the protective cap is chamfered.

8. The protective cap according to claim 1, further comprising:
a fixing member including a plurality of protrusions on an inner peripheral surface of the through hole.

9. The protective cap according to claim 1, further comprising:
a portion having a rubber hardness of 30 or more and 90 or less.

10. The protective cap according to claim 1, further comprising:
a cushion portion including a material having a rubber hardness that is lower than a rubber hardness of a portion other than the cushion portion, on the surface of the topside.
